(19) United States
(12) Patent Application Publication
(10) Pub. No.: US 2015/0233049 A1
(43) Pub. Date: Aug. 20, 2015

(54) WASH-DURABLE ANTIMICROBIAL TEXTILES AND METHODS OF MANUFACTURE

(71) Applicant: NanoHorizons Inc., Bellefonte, PA (US)

(72) Inventors: James Delattre, State College, PA (US); James Kundrat, San Francisco, CA (US); Matthew Henry, State College, PA (US); Robert Haupt, Bellefonte, PA (US)

(21) Appl. No.: 14/419,083

(22) PCT Filed: Aug. 2, 2013
(86) PCT No.: PCT/US2013/053366

§ 371 Date: Feb. 2, 2015

Related U.S. Application Data
(60) Provisional application No. 61/678,812, filed on Aug. 2, 2012.

(51) Int. Cl. D06M 13/503; A01N 25/10; A01N 59/16

(52) U.S. Cl. CPC D06M 13/503; A01N 59/16; A01N 25/10

(57) ABSTRACT

This invention is directed to a wash-durable textile article comprising a textile substrate, an antimicrobial metal nanoparticle, and a linking agent chemically bonding to the antimicrobial metal nanoparticle to the textile substrate. In addition, this invention also includes a method of manufacturing a wash-durable antimicrobial textile, the method comprising the steps of providing an antimicrobial metal nanoparticle, reacting the antimicrobial metal nanoparticle with a linking agent to provide a functionalized antimicrobial metal nanoparticle, and reacting the functionalized antimicrobial metal nanoparticle with a textile substrate to cause the linking agent to attach to the textile substrate to thereby form a wash-durable antimicrobial textile article.

### CROSS-REFERENCE TO RELATED APPLICATIONS

This application claims priority to U.S. Provisional Patent Application Ser. No. 61/678,812 filed on Aug. 2, 2012.

### FIELD OF THE INVENTION

This invention relates to improvements in wash-durable, and preferably non-conductive, metal-based antimicrobial textiles. Such metals preferably comprise silver; however, other antimicrobial metals, such as zinc, iron, copper, nickel, cobalt, aluminum, gold, manganese, magnesium, and the like, may be used, whether alone or in any combination. No textile binder is required, and preferably none is present in the antimicrobial textile article.

### BACKGROUND OF THE INVENTION

It is well-known that metal-based antimicrobial materials cm be incorporated into textiles to provide antimicrobial properties to the textiles. For example, it is known to provide an antimicrobial synthetic fiber by extruding a polymer having an antimicrobial material, such as silver, dispersed therein. However, such extrusion-based textiles and methods are fraught with problems such as non-uniform dispersion of the antimicrobial material, losses in manufacturing efficiency, compromised fiber strength, and increased abrasiveness of the fiber, among other things.

It is also known to incorporate antimicrobial materials into a binder-based coating that can be applied to the surface of a textile. For example, U.S. Pat. Nos. 7,291,570, 6,640,371, 6,946,433, 6,821,936, 6,641,829, 6,461,386, 6,454,813 and 654,668 (assigned to Milliken & Co.) describe methods of adherence of an antimicrobial material to a target yarn and/or fabric through utilization of a binder system to thereby form a topical coating on the textile. Milliken's patents specify a polymeric binder having very particular criteria and characteristics for durably adhering antimicrobial particles to the surface of the textile, and for providing wash durability of the adhered particles to the textile over time. Indeed, the sole binder examples provided in U.S. Pat. No. 7,291,570 include a resin or thermoplastic, and particularly melamine resins and polyvinyl chloride-containing polymers. Such binders act as a non-water soluble glue to adhere and retain the antimicrobial material particles on the surface of the textile as part of a topical coating. Among other disadvantages, such binder-containing coatings alter the surface properties of the textile, such as by protruding antimicrobial particles that provide an undesirable abrasive property, the binder imparting a plastic feel and look, and altered wicking characteristics, sorption, air permeability, and dye and dyeing characteristics of the textile article, due at least in part to the coated surface the textile formed by the use of binders. Additionally, because the binder systems taught by Milliken specify are non-water soluble binders, their methods of manufacture require solvents that alter the textile and its properties, that exposes users to residual solvent, and that creates yet another environmentally undesirable manufacturing waste stream.

For all these reasons, there remains an unmet need for a wash-durable antimicrobial textile that retains desirable textile properties while providing new desirable properties, including aqueous methods of manufacture that avoid the use of harsh solvents and binders that otherwise alter the characteristics of the original textile substrate in the final textile article. There is therefore an equally desirable and unmet need for methods of producing such a textile in a water-based system, without the need for binders, solvents, or other undesirable chemicals.

### SUMMARY OF THE INVENTION

This application relates to improvements in wash-durable, and preferably non-conductive, metal-based antimicrobial textiles, and the methods of manufacture of such textiles. The textile essentially comprises: 1) an antimicrobial particle; 2) a textile; and 3) a linking agent that connects the antimicrobial particle to the textile article.

### DETAILED DESCRIPTION OF THE PREFERRED EMBODIMENTS

In one embodiment, the improvement comprises a novel textile article. The textile article essentially comprises: 1) an antimicrobial material particle; 2) a textile; and 3) a linking agent, that connects the antimicrobial particle to the textile article. In an embodiment the textile is wash-durable because the metal-based antimicrobial is chemically bound to the yarn, fiber, or other component of the textile by a linking agent in a binderless system and method.

It is thus an object of the invention to provide a simple manner of effectively treating a textile to provide a wash-durable metal-based antimicrobial article. A further object of the invention is to provide a textile that is wash-durable and continuously reduces and/or removes malodors from the target surface through the utilization of a metal-based antimicrobial that is chemically bonded to the substrate by a linking agent. Another object of the invention is to provide an aesthetically pleasing textile which is non-electrically conductive, wash durable, non-yellowing, non-irritating to skin, and which provides either or both antimicrobial or odor-reducing properties.

Furthermore, in order to avoid certain problems, it is highly desirable to provide an electrically non-conductive textile surface. Further, although antimicrobial activity is one desired characteristic of the inventive textile, this is not a required property of the inventive article. Odor-reduction, heat retention, distinct colorations, reduced discolorations, improved yarn and/or fabric strength, resistance to sharp edges, etc., are all either individual or aggregate properties which may be accorded the user of the technology described herein

The antimicrobial material particle must comprise at least one type of metal-based particle selected from among metal particles, metal-ion containing particles, or mixtures thereof. “Metal” as used herein means any recognized among the periodic chart (including transition metals, such as, without limitation, silver, zinc, copper, nickel, iron, magnesium, manganese, vanadium, gold, cobalt, platinum, and the like, as well as other types including, without limitation, aluminum, tin, calcium, magnesium, antimony, bismuth, and the like). More preferably, the metals utilized within this invention, are generally those known as the transition metals, the more preferred transition metals being zinc, gold, copper, nickel, manganese, and iron. Such transition metals provide the best overall desired characteristics to the modified textile, such as, preferably, antimicrobial and/or odor reducing characteristics, certain colorations, good light fastness, and, most importantly, wash durability on the target substrate.

The term “metal particle” means any particle within which the metal is present in its pure non-ionic state (silver nanoparticles, as one example). The metal particle (or any compound in which it resides) may, optionally, be produced through a reduction procedure, whether in situ or otherwise.

The term “metal-ion containing” encompasses compounds within which the ionic species of metals are present (such as metal oxides, including, as mere examples, zinc oxide for Zn²⁺, silver oxide for Ag⁺, and iron oxide for Fe²⁺ or Fe³⁺, or, as alternatives, ion-exchange resins, zeolites, or, possibly substituted glass compounds, which release the particular metal ion bonded thereto upon the presence of other anionic species).

“Metal-based” means the metal is provided in its elemental form, in an ionic form, or in combinations thereof.

The term “nanoparticle” means a particle having a largest diameter of less than about 1 μm, and more preferably less than about 100 nm, and most preferably less than about 70 nm.

The term “linking agent” means a chemical having at least a first reactive (aka “functional”) group with an affinity for a metal and at least one reaction reactive group with an affinity for a textile. The linking agent may comprise one or more chemicals, so long as the linking agent is a continuous molecule that links the metal to the textile upon completion of a chemical bond at the first site and second site. Without limitation, the linking agent can comprise organic chemicals, inorganic chemicals, and combinations thereof. By way of non-limiting example, suitable linking agents that are compatible with the examples herein include: citrate; ascorbic acid; thiol/mercaptans terminated linking agents; carboxylases/carboxylic acid moiety; thioglycolic acid/mercaptoacetic acid; 4-mercaptobutryic acid; mercaptosuccinic acid; thiolactic acid; 1-mercapto-2-propanol; meso-2,3-dimercaptosuccinic acid; 11-mercaptoundecanoic acid; sulfones/sulfonic acid moiety; 2-Mercapto-S-benzimidazolesulfonic acid sodium salt; 3-mercapto-1-propane sulfonic acid; peptides/proteins; sulfo-NHS (For use on animated cottons); sulfo-SMCC (For use on animated cottons); 2-mercaptopyridine-N-oxide sodium salts, among others.

Optionally, the textile article can include additional additives to enhance any desirable property of the textile article, such as color, look, feel, color, smoothness, abrasiveness, odor, fragrance, electrical properties, insulative properties, wicking properties, resistance to degradation, environmental stability, and antimicrobial and antifungal properties, for example.

In an example, an additive comprising a cross-linker may be included to promote chemical bonding among the textile components, thereby improving the durability of the textile and its resistance to environmental degradation. Without limitation, suitable exemplary cross-linkers that are compatible with the examples herein include, for example: formaldehyde; glyoxal; glutaraldehyde; disulfosuccinimydyl suberate (BS3); carbodiimides (e.g. 1-Ethyl-3-[3-dimethylaminopropyl]carbodiimide hydrochloride (aka EDC)), among others.

In another example, an additive comprising a lubricant and/or sizing agent may be included to reduce abrasion of the treated textile and its yarns and/or fibers after assembly of the metal particle onto the textile by the linking agent. Such an additive, though preferably present in very low concentrations, can significantly improve the handling properties of the treated textile in post-manufacture processes such as knitting of treated yarns to form a woven textile article. Exemplary lubricants and sizings include those commonly used in textile manufacturing, including but not limited to: Starches and starch, derivatives, such as non-modified starch, modified starch such as dextrinized starch, hydrolyzed starch, esterifed starch, etherified starch; water soluble polymeric lubricants such as polyvinyl, alcohol, (such as Celvol™ brand PVA by Celanese chemicals); celluloses such as carboxymethyl cellulose, or other celluloses, proteins, polypeptides, and gelatins (whether from plant or animal sources).

In an example, antimicrobial, silver particles are be bound to the textile by providing a functionalized silver metal particle. In this example, the functionalized silver includes a linking agent having a functional group covalently bound to the silver (such as a sulfur-containing functional group), the linking agent further having a dye group that is compatible for covalent bonding to a surface of the textile. In this example, the functionalized silver is water soluble. The functionalized silver is suspended in an aqueous solution, and upon contact with the textile, the dye group of the linking agent becomes chemically bound to surface of the textile. Preferably, the step of contacting is performed using standard industrial dying equipment such as package dying equipment, as further described herein. In any case, the metal-based antimicrobial material remains attached to the textile by the linking agent even after a substantial number of standard launderings and dryings and the textile thus retains the antimicrobial activity provided by the presence of the antimicrobial material.

In a preferred example, the antimicrobial material is a nanoparticle comprising at least one metal preferably silver and/or zinc.

Accordingly, this invention encompasses a treated substrate comprising a non-electrically conductive arrangement of metal-based antimicrobial particles selected from the group consisting of metal particle-containing compounds, metal ion-containing compounds, and any combinations thereof, and a substrate comprising a yarn or a fabric; wherein said particle, compound or compounds are chemically bonded to the substrate by a linking agent. Preferably, at least about 30%, of the originally chemically bonded metal-containing compound remains on the substrate after at least 10 washes, said washes being performed in accordance with the wash procedure as part of AATCC Test Method 130-1981. Still more preferably at least 50% of the metal-containing compounds remain after 10 washes, more preferably 60% after 10 washes, and most preferably at least 75% after the same number of washes. Furthermore, it is also highly preferred that at least 30% of the compound is retained after 15 washes, 20 washes, and most preferably about 30 washes.

Also, and alternatively, this invention encompasses methods of manufacturing a treated substrate comprising a metal-based antimicrobial compound selected from the group consisting of metal particle-containing compounds, metal ion-containing compounds, and any combinations thereof, and a substrate selected from the group consisting of a yarn, a fabric comprised of individual yarns; wherein said compound or compounds is chemically bonded to at least a portion of the surface of said substrate by a linking agent, and wherein the method does not require a binder; and wherein said treated substrate exhibits a log kill rate for Staphylococcus aureus of at least 1.5, preferably above 2.0, more preferably above 3.0, and a log kill rate for Klebsiella pneumoniae of at least 1.5, preferably above 2.0, and more preferably above 3.0, both as tested in accordance with AATCC Test Method 100-1993 for 24 hour exposure, after at least 10 washes, said washes performed in accordance with the wash procedure as part of AATCC Test Method 130-1981. Such an invention also encompasses the different methods of producing such a treated substrate. The wash durability test noted above is standard and, as will be well appreciated by one of ordinary skill in this art, is not intended to be a required or limitation within this invention. Such a test method merely provides a standard, which, upon 10 washes in accordance with such, the inventive treated substrate will not lose an appreciable amount of its electrically non-conductive metal finish.

The amount of metal-based antimicrobial retained on the treated substrate may be measured in any standard manner, such as, for example, inductively coupled plasma (ICP), X-ray fluorescence (XRF), or atomic absorption (AA) spectroscopic analysis. Or, again, in the alternative, the durability of certain articles may be determined (i.e., the retention of metal-based antimicrobial in relation to antimicrobial performance. Thus, with an antimicrobially effective treatment, the exhibition of log kill rates for Klebsiella pneumoniae or Staphylococcus aureus after 24 hours exposure in accordance with AATCC Test Method 100-1993 of at least 1.5, and higher, as noted above, for both after 10 washes in accordance with AATCC Test Method 103-1981. Preferably, these log kill rates are above 2.0, more preferably 2.5, and most preferably at least 3.0. Again, such log kill rates after the minimum number of washes symbolizes the desired durability level noted above.

Nowhere within the prior art has such a specific treated substrate or method of making thereof been disclosed, utilized, or fairly suggested. The closest art is described in the patents assigned to Milliken (earlier referred to herein) which involve the use of a binder system to adhere antimicrobial compounds to the surface of a yarn or textile. The resulting Milliken textile is not highly electrically conductive, possibly because the non-water soluble binder itself is non-conductive and surrounds the fiber, as well as throughout, between, and/or around the otherwise-conductive antimicrobial metal-containing compounds. Nowhere, has a binderless, wash-durable metal-based antimicrobial treatment as now claimed been mentioned or alluded to. And nowhere is there a textile having antimicrobial metal nanoparticles covalently bound to the textile, let alone by a linking agent. Nanoparticles are particularly difficult to disperse and apply evenly and consistently to any substrate—only the inventive methods herein accomplish that result to provide a novel textile.

Any textile (yarn, fabric, or combinations thereof) may be utilized as the substrate within this application. Thus, natural (cotton, wool, and the like) or synthetic fibers (polyesters, poly-amides, polyolefins, and the like) may constitute the target substrate, either by itself or in any combinations or mixtures of synthetics, naturals, or blends or both types. As for the synthetic types, for instance, and without intending any limitations therein, polyolefins, such as polyethylene, polypropylene, and polybutylene, halogenated polymers, such as polyvinyl chloride, polyesters, such as polyethylene terephthalate, polyester/polyethers, polyamides, such as nylon 6 and nylon 6,6, polyurethanes, as well as homopolymers, copolymers, or terpolymers in any combination of such monomers, and the like, may be utilized within this invention. Nylon-6, nylon-6,6, polypropylene, and polyethylene terephthalate (a polyester) are particularly preferred.

Furthermore, the substrate, whether original or post-processing as a wash-durable antimicrobial textile article made by the methods described herein, may be dyed or colored to provide other-aesthetic features for the end user with any type of colorant, such as, for example, poly(oxyalkylenated) colorants, as well as pigments, dyes, tints, and the like. Other additives may also be present on and/or within the target fabric or yarn, including antistatic agents, brightening compounds, nucleating agents, antioxidants, UV stabilizers, fillers, permanent press finishes, softeners, lubricants, curing accelerators, and the like. Particularly desired as optional and supplemental finishes to the inventive fabrics are soil release agents, which improve the wettability and washability of the fabric. Preferred soil release agents include those which provide hydrophilicity to the surface of polyester. With such a modified surface, again, the fabric imparts improved comfort to a wearer by wicking moisture. Additionally, other potential additives and/or finishes may include water repellent fluorocarbons and their derivatives, silicones, waxes, and other similar waterproofing materials.

Concerning the finished wash-durable antimicrobial textile articles described herein, a novel and unprecedented property of some of the embodiments is that most, if not all, of the textile properties of the original textile substrate are substantially preserved, and are exhibited in the finished wash-durable antimicrobial textile articles. For example, the wicking, absorption, adsorption, dyeing, and other measurable characteristics are preserved, and are preferably quantifiable to at least 25% of the measured property in the original textile prior to coating using the methods herein. For example, with regard to wicking, due to the hydrophilic nature of the surface modified particles in examples herein, the finished textile articles described herein exhibited wicking properties that were at least 25% of the original textile, and as high as 99% of the original textile in examples using nylon. Testing of the wicking capability using test method AATCC 79 showed that woven fabrics produced using the exemplary silver metal nanoparticles attached by linking agents to nylon fibers had a 2.5 second absorption time while woven fabrics prepared using competitor's binder-based silver-coated nylon yarns showed no absorption of water. Other inherent properties of the original uncoated substrates are maintained by the inventive methods herein, whereas the prior art binder-based coating methods result in masking or eliminating the properties of the original substrate. For example, we have also confirmed that our yarn can be dyed whereas the traditional silver-coated nylon do not.

With a reducing agent, the salts utilized for this purpose are thus preferably silver (I) nitrate, nickel (II) perchlorate, copper (II) acetate, and iron (II) sulfate.

Generally, such a metal compound is added in an amount of from about 0.01 to 40% by total weight of the particular treatment composition; more preferably from about 0.05 to about 30%; and most preferably from about 0.1 to about 30%, all dependent upon the selected method of application. The metal compound is then added to the target substrate in a) amounts of between 0.01 and 1.0 ounces per square yard, or, alternatively, b) from about 0.01 to about 5% owf, depending on the selected application and method for measuring. Such proportion's provide the best antimicrobial and/or odor-reducing performance in relation to wash durability, electrical non-conductivity, and overall cost. Preferably, this metal compound add-on weight is a) about 0.1, or b) about 2.0% owf.

Furthermore, the inventive substrates necessarily do not exhibit any appreciable electrical conductivity (due to the low amounts of metal present and thus the nonexistence of any percolation over or through the target substrate) as measured by attaching a two-inch by two-inch fabric specimen to two electrodes and applying a voltage gradient of about 100 volts per inch through the fabric (i.e., in accordance with AATCC Test Method 76-1978). The measured resistance in ohms per square inch should exceed about 10,000, preferably 1,000,000, and most preferably 1×10⁹ in order to provide a substantially non-electrically conductive fabric.

The selected substrate may be any of an individual yarn, a fabric comprising individual fibers or yarns (though not necessarily previously coated yarns), or a film (either standing alone or as laminated to a fabric, as examples). The individual fibers or yarns may be of any typical source for utilization within fabrics, including natural fibers (cotton, wool, ramie, hemp, linen, and the like), synthetic fibers (polyolefins, polyesters, polyamides, polyaramids, acetates, rayon, acrylics, and the like), and inorganic fibers (fiberglass, boron fibers, and the like). The target yarn may be of any denier, may be of multi- or mono-filament, may be false-twisted or twisted, or may incorporate multiple denier fibers or filaments into one single yarn through twisting, melting, and the like. The target fabrics may be produced of the same types of yarns discussed above, including any blends thereof. Such fabrics may be of any standard construction, including knit, woven, or non-woven forms.

The yarns are preferably incorporated within specific fabrics, although any other well known utilization of such yarns may be undertaken with the inventive articles (such as tufting for carpets). The inventive fabrics may also be utilized, in any suitable application, including, without limitation, apparel, upholstery, bedding, wiping cloths, towels, gloves, rugs, floor mats, drapery, napery, bar runners, textile bags, awnings, vehicle covers, boat covers, tents, and the like.

Another preferred alternative concerns the treating of individual fibers. Such an alternative has proven very effective, most particularly in a package dyeing method. In such a procedure, an aqueous dye bath comprising the desired metal-based antimicrobial compounds (and without any binder agent, and preferably without any non-aqueous solvents) is pumped through a tightly wound spool of yarn (or fiber). This is generally a rather difficult process to perform effectively since the particle sizes of the constituent dye bath solids might interfere with the requisite pump pressure to force the dye bath liquor through the entire “package” of yarn. Furthermore, such a dyeing method must produce a uniform treatment of all the portions of the target yarn throughout the “package”; particle size and thoroughness of mixing are thus of vital importance to impart of even treatment over the entire yarn. Surprisingly, this procedure works very well for imparting a wash-durable metal-based antimicrobial on the yarn, particularly when the antimicrobial consists of nanoparticles, such as the functionalized silver nanoparticles described herein. Upon treatment of target yarns, such yarns can then be woven, knit, or incorporated within a non-woven fabric structure to form a textile. The textile exhibits similar colorations, log kill rates, and the like, at discrete locations of the textile. Without intending to be bound to any specific theory, it is believed that the linking agent appears to bond covalently to the metal-based antimicrobial using a first reaction site such as a sulfur-containing reaction site on the linking agent, and to covalently bond to the textile using a second reaction site, such as a dye group reaction site on the linking agent (and/or using a dye group on the textile, such as a pre-dyed yarn.) Very surprisingly, the desired metal-particle and linking agent compounds were small enough to be forced through the yarn “package” in order to treat the entire target yarn, thereby providing a substantially uniform modified textile throughout the entire spool. In such an alternative method, the high pressure procedure necessary for providing the antimicrobial metal and linking agent reaction onto the target yarns must be sufficient to permit penetration of the solid compounds into the actual yarn structure. A high temperature may be desired to permit “opening” of the fiber structure to facilitate such solids introduction within a solid yarn, and especially for polyester and other synthetic textiles. In general, the high pressure conditions must be from about 0.1 and 100 pounds per square inch with an exposure time of from about 5 seconds to about 5 hours at a temperature in the range from about 25° to about 325° C. Such conditions are most readily provided within a jet dye, closed vessel system, and appears to work most readily for package dyed yarns. The type of fiber is consequential only to the extent that certain temperatures permit easier penetration within certain fibers. Thus, natural fibers (such as cotton) require relatively low temperatures to “open” of the cellulosic structure; nylon requires a much higher temperature (to exceed its glass transition temperature, typically) to provide the most effective antimicrobial characteristics. For the most part, the high pressure may force some solid particles into the yarns, and allow the linking agent to bond the metal to the yarn throughout (including inside) the yarn, such as a braided yarn having interstitial spaces. Importantly, because of the linking agent and its affinity for both the metal and the textile itself, no binder agent is provided, and none is necessary to aid in antimicrobial particle retention.

### EXAMPLES

Equipment: Package dye machine with heating system. This is a pressurized vessel that pumps liquid used to apply dyes to yarns. The yarn is placed on a perforated tube wrapped with yarn (called a package) inside the vessel. Dyes and chemicals are then added to the vessel to cause a reaction between the bath and the yarn as the bath is circulated through the center of the package and is pushed to the exterior. One of the technical challenges of package dyeing is getting uniform uptake of dye. Looking at a cross section of the package, it is not uncommon to find high uptake at the inside and outside edges of the package, but lower or no uptake in the center of the package. This “filtering effect” is magnified for larger particles and for narrower yarns. Drying oven—For heat treating yarn packages. Preferably, in the example drying is performed at between about 220-230° F. (105-110° C.) for up to 24 hours.

Materials:

Textile—Preferably nylon yarn, cotton yarns, or combinations thereof, although any dyeable textile material is acceptable with this embodiment.

Water.

Silver particles (such as SmartSilver nanoparticles by NanoHorizons, Inc) in an aqueous formulation know as SmartSilver PRO, containing: 1) nominally 10% silver particles functionalized with a reactive linking agent (such as 11 -mercaptoundecanoic acid, 3-mercapto-1-propanesulfonate, or other sulfur-containing linking agent); 2) water-soluble stabilizer (gelatin, or other water-soluble protein/polypeptide); and 3) sodium nitrate (or other nitrate salt).

During and/or after the silver bonding to the linking agent and the linking bonding to the yarn of the textile, the following additional chemicals are also added, as further described herein: 4) Exhausting Agent—such as zinc nitrate hexahydrate, or other salts known to promote exhaustion of dyes onto textile substrates; 5) Acid (for pH adjustment)—such as hydrochloric acid, acetic acid, formic acid or other organic/inorganic acids commonly used in textile processing; 6) Cross-linker—such as glyoxal; and 7). Optionally, water soluble lubricant or sizing agent—such as poly(vinyl alcohol) (aka “PVA”) to improve crocking qualities

Example Process (scalable and adjustable to achieve desired processes and products). A 2-pound package of nylon yarn, is placed in a package dye machine. The machine is filled with approximately 5 gallons of water. The machine's pump is turned on and water flows continuously from the outside of the package to the inside at a rate of (TBD). The water temperature is heated to approximately 200° F. and held for the duration of the treatment process. 151 g of SmartSilver™ PRO is dissolved in 1.5 L hot water (approximately 140° F.) for 10 minutes. SmartSilver™ PRO solution is added to the package dye bath. 100 ml of 3.7% hydrochloric acid is added to the package dye bath, bringing the pH of the bath to between 3.0 and 4.5. This action is designates the start time of the treatment process (T=0).

At T=10 minutes, 1.0 g of seine nitrate hexahydrate (dissolved in a minimum amount of water) is added to the package dye bath. At T=20 minutes, 20 g of zinc nitrate hexahydrate (dissolved in a minimum amount of water) is added to the package dye bath. At T=30 minutes, 30 g of zinc nitrate hexahydrate (dissolved, in a minimum amount of water) is added to the package dye bath. By T=40 minutes, the package dye bath has turned from dark brown and opaque to nearly clear and colorless, indicating that all silver has exhausted onto the nylon fiber. 120 ml of glyoxal (40% solution) is added as a fixative. At T=60 minutes, the package dye bath is drained, and the machine is refilled with clean water. The treated nylon yarn is rinsed, again using outside to inside flow. At T=70 minutes, the rinse water is drained and the treated nylon yarn is removed from the machine. Optionally, poly(vinyl alcohol) (PVA) may be added to the rinse water at 0.05% by weight of bath to improve abrasion resistance and processing durability. The yarn is dried and heat-set at 225° F. for 24 hours.

Unique Process Features. The exemplary method and the resulting textile article and composition is unique in that it reacts with yarns, like a dye, and therefore does not require a binder. Binders are not desirable because they can break down in the vessel and coat the walls, impact the ‘hand’ (touch and feel) of the yarn by making them stiff impact the moisture transport properties of the yarn, or promote flammability. The binderless process is also an exhaust process, meaning that the bath clears of silver by dropping the pH with acid and adding chemicals that create an electrostatic attraction between the suspended silver particles and the yarn. Exhaustion of the bath is promoted by the addition of the zinc nitrate hexahydrate. This is a common method used in dyeing. Exhaustion is highly desirable because it leaves no unreacted chemicals in the bath which require special disposal. Other salts to promote exhausting onto fiber include: zinc nitrate, magnesium nitrate, calcium nitrate, sodium nitrate, sodium sulfate, and sodium thiosulfate, and the like. It is not expected that a binderless additive could be applied uniformly through the package and fully exhaust. The staged addition of the zinc nitrate hexahydrate is critical to achieving uniform application and full exhaustion. The surface functional groups of the linking agent bind with the silver or other metal particle, leaving a second reaction site available on the linking agent to bond with the textile, such as on yarns, thereby providing an assembly having very good metal retention, wash-durability, and abrasion resistance. Additionally, the number of covalent bonds in the assembly (e.g. between and among metal particles, the linking agent, and the textile components) can be increased, increasing abrasion resistance, such as by adding a crosslinker such as gloxyal. The abrasion resistance of the yarn can be further improved with a rinse lubricant or sizing agent (such as PVA) post-adherent treatment step listed above. This optional step is performed subsequent to the silver-textile bonding and exhausting steps.

Final Product. The exemplary treated yarn textile is characterized by: 1) having a dark grey color with metallic sheen, 2) containing approximately 2% silver by mass, 3) having electrical insulating properties, i.e. non-conductive; 4) achieving 2-log to 4-log reduction against various gram-positive and gram-negative bacteria according to ASTM c2149 and AATCC TM100 antimicrobial testing, even after 25 laundering cycles, and; 5) having excellent abrasion resistance (meaning that the silver does not abrade off of the yarn). The appearance of the exemplary treated yarn is not only desirable, but is surprising since silver particles when dispersed (such as nanoparticulate silver in any solution) appear as a yellow/brown color, which is not aesthetically pleasing. However, when the silver particles are bonded to the textile as described herein by a linking agent, and become more closely packed on the fiber surface they optically behave like a metal coating, while still being non-conductive. In addition to the real value of the antimicrobial, non-conductive, and wash-durable properties of the textile articles herein, we expect the textile to be readily accepted by textile companies and consumers because of the attractive silver-colored, metallic appearance. Products that exhibit a metallic silver luster are historically considered precious and valued in the marketplace, and that same advantage is expected to apply to the inventive textiles herein.

The description herein provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

While the principles of the invention have been described above in connection with preferred embodiments, it is to be clearly understood that this description is made only by way of example and not as a limitation of the scope of the invention.

1. A wash-durable textile article comprising a textile substrate, an antimicrobial metal nanoparticle, and a linking agent chemically bonding to the antimicrobial metal nanoparticle to the textile substrate, wherein the linking agent does not comprise a binder, and wherein the textile article exhibits antimicrobial properties after 10 washes in accordance with AATCC Test Method 103-1981, including the exhibition of log kill rates for at least one organism selected from the group consisting of Klebsiella pneumonia, Staphylococcus aureus, and combinations thereof after 24 hours exposure of at least 1.5.

2. The wash-durable textile article of claim 1, wherein the linking agent comprises a functional group compatible with covalent chemical bonding to the antimicrobial metal nanoparticle, and wherein the linking agent further comprises a dye group compatible with covalent chemical bonding to the textile substrate.

3. (canceled)

4. The wash, durable textile article of claim 3, wherein the yarn comprises at least one fiber-selected from the group consisting of: natural fibers, cotton, wool, ramie, hemp, linen, synthetic fibers, acetates, rayon, acrylics, polyesters, polyamides, polyolefins, polyethylene, polypropylene, polybutylene, halogenated polymers, polyvinyl chloride, polyethylene, terephthalate, polyester/polyethers, polyamides, nylon 6, nylon 6,6, polyurethanes, homopolymers, copolymers, terpolymers, inorganic fibers, fiberglass, boron, and combinations thereof.

5. The wash durable textile article of claim 4, wherein the antimicrobial metal nanoparticle is selected from the group consisting of: zinc, iron, copper, nickel, cobalt, aluminum, gold, manganese, magnesium, vanadium, aluminum, tin, calcium, antimony, bismuth, and combinations thereof.

6. The wash durable antimicrobial textile article of claim 5, wherein the linking agent is selected from the group consisting of: citrate, ascorbic acid, thiol and mercaptans terminated linking agents, carboxylates/carboxylic acid moieties, thioglycolic acid and mercaptoacetic acid, 4-mercaptobutryic acid, mercaptosuccinic acid, thiolactic acid, 1-mercapto-2-propanol, meso-2,3-dimercaptosuccinic acid, 11-mercaptoundecanoic acid, sulfones and sulfonic acid moieties, 2-Mercapto-5-benzimidazolesulfonic acid sodium salts, 3-mercapto-1-propane sulfonic acid, peptides, proteins, sulfo-NHS, sulfo-SMCC, 2-mercaptopyridine-N-oxide sodium salts, and combinations thereof.

7. The wash durable antimicrobial textile of claim 6, wherein the wash-durable textile article is non-conductive in accordance with AATCC test Method 76-1978 to yield a measured resistance of at least 10,000 ohms per square inch.

8. The wash durable antimicrobial, textile of claim 7, further comprising a cross-linker selected from the group consisting of: formaldehyde, glyoxal, glutaraldehyde, disulfosuccinimydyl suberate (BS3), carbodiimides, 1-Ethyl-3-[3-dimethylaminopropyl]carbodiimide hydrochloride, and combinations thereof.

9. The wash durable antimicrobial textile of claim 1, wherein the antimicrobial nanoparticle comprises silver, wherein the textile substrate comprises polyamide-6,6, and wherein the linker comprises an 11-mercaptoundecanoic acid linker, and wherein the textile optionally further comprises a glyoxyl cross linker.

10. The wash-durable antimicrobial textile article of claim 1, wherein the wash-durable antimicrobial textile article exhibits wicking characteristics that are at least 25% of the wicking characteristics exhibited by the textile substrate as measured by test method AATCC 79.

11. The wash-durable antimicrobial textile article of claim 10, wherein the wash-durable antimicrobial textile article exhibits dyeing characteristics that are at least 25% of the dyeing characteristics exhibited by the textile substrate.

12. A method of manufacturing a wash-durable antimicrobial textile, the method comprising the steps of providing an antimicrobial metal nanoparticle, reacting the antimicrobial metal nanoparticle with a linking agent to provide a functionalized antimicrobial metal nanoparticle, and reacting the functionalized antimicrobial metal nanoparticle with a textile substrate to cause the linking agent to attach to the textile substrate to thereby form a wash-durable antimicrobial textile article, wherein the linking agent does not comprise a textile binder, and wherein the wash-durable antimicrobial textile article exhibits antimicrobial properties after 10 washes in accordance with AATCC Test Method 103-1981, including the exhibition of log kill rates for at least one organism selected from the group consisting of Klebsiella pneumoniae or Staphylococcus aureus after 24 hours exposure of at least 1.5.

13. The method of claim 12, wherein the textile substrate comprises a yarn, wherein the yarn comprises at least one fiber selected from the group consisting of natural fibers, cotton, wool, ramie, hemp, linen, synthetic fibers, acetates, rayon, acrylics, polyesters, polyamides, polyolefins, polyethylene, polypropylene, polybutylene, halogenated polymers, polyvinyl chloride, polyethylene terephthalate, polyesterlpolyethers, polyamides, nylon 6, nylon 6,6, polyurethanes, homopolymers, copolymers, terpolymers, inorganic fibers, fiberglass, boron, and combinations thereof.

14. The method of claim 13, wherein the antimicrobial metal particle is an antimicrobial metal nanoparticle selected from the group consisting of silver, zinc, iron, copper, nickel, cobalt, aluminum, gold, manganese, magnesium, vanadium, aluminum, tin, calcium, antimony, bismuth, and combinations thereof.

15. The method of claim 14, wherein the linking agent is selected from the group consisting of: citrate, ascorbic acid, thiol and mercaptans terminated linking agents, carboxylates and carboxylic acid moieties, thioglycolic acid and mercaptoacetic acid, 4-mercaptobutryic acid, mercaptosuccinic acid, thiolactic acid, 1-mercapto-2-propanol, meso-2,3-dimercaptosuccinic acid, 11-mercaptoundecanoic acid, sulfones and sulfonic acid moieties, 2-Mercapto-5-benzimidazolesulfonic acid sodium salts, 3-mercapto-1-propane sulfonic acid, peptides, proteins, sulfo-NHS, sulfo-SMCC, 2-mercaptopyridine-N-oxide sodium salts, and combinations thereof.

16. The method of claim 12, wherein the step of reacting the functionalized metal particle with a textile substrate to cause the linking agent to attach the metal particle to the textile substrate to form a wash-durable textile article is performed in an aqueous bath.

17. The method of claim 16, wherein the aqueous bath is dye bath provided in a textile dying apparatus.

18. (canceled)

19. The method of claim 12, wherein the step of providing an antimicrobial metal nanoparticle comprises providing the nanoparticles as an aqueous formulation comprising at least 10% by weight metal nanoparticles, and wherein the step of reacting the metal nanoparticle with a linking agent to provide a functionalized antimicrobial metal nanoparticle comprises reacting the metal nanoparticle with a sulfur-containing linking agent to form a functionalized antimicrobial metal nanoparticle.

20. The method of claim 19, further comprising the step of adding at least one exhausting agent selected from the group consisting of zinc nitrate hexahydrate salts known, to promote exhaustion of dyes onto textile substrates, and combinations thereof.

21. The method of claim 19, further comprising the step of adding to the bath at least one acid for pH adjustment to the bath, the acid selected from the group consisting of hydrochloric acid, acetic acid, formic acid, and organic or inorganic acids compatible with the yarn as a textile element, and optionally adding to the bath at least one cross-linker, and optionally adding to the bath at least one water soluble lubricant or water soluble sizing agent.

22. (canceled)

23. The method of claim 12, further comprising a step of dyeing the wash-durable antimicrobial textile article.
